(19) United States
(12) Patent Application Publication
(10) Pub. No.: US 2009/0155485 A1
(43) Pub. Date: Jun. 18, 2009

(54) Rapid curing wood putty based on frontal polymerization

(76) Inventors: Charles E. Hoyle, Hattiesburg, MS (US); John A. Pojman, New Orleans, LA (US)

Correspondence Address: HOWREY LLP-HN, C/O IP DOCKETING DEPARTMENT, 2941 FAIRVIEW PARK DRIVE, SUITE 200, FALLS CHURCH, VA, 22042-7195, US

(21) Appl. No.: 12/002,675

(22) Filed: Dec. 18, 2007

(51) Int. Cl. C08F 2/48

(52) U.S. Cl. 427/517

(57) ABSTRACT

The present invention provides a method for rapidly curing wood putty utilizing frontal polymerization. The reaction is initiated with UV light, and a reaction front propagates through the putty, completing the cure in seconds. A depth of cure of more than 1 cm deep of the wood putty is rapidly achieved.

### BACKGROUND OF THE INVENTION

In photoinitiated frontal polymerization, a combination of photoinitiator(s) and thermal initiator(s) is used in the system. Polymerization starts at the top layer as a result photoinitiation. The heat generated from photopolymerization causes thermal decomposition of thermal initiators, producing initiating radicals that initiate the polymerization; the polymerization front travels downwards from the surface to achieve a complete cure. Similar to conventional thermal frontal polymerization, the amount of heat produced is essential in increasing the temperature of the immediate, uncured layer to the decomposition temperature of thermal initiators and to maintain the traveling front. Thermally initiated frontal polymerization has been used to cure thick samples; typically with a low content (<10 wt %) of fillers, if applicable. However, current technology requires many hours for the putty to cure.

An advancement in the art would provide a wood putty that can cure rapidly even with a high filler content.

### SUMMARY OF THE INVENTION

The present invention provides a method for rapidly curing wood putty utilizing frontal polymerization. The invention is a method for repairing a wood defect comprising: applying to the wood defect a wood putty comprising: a multifunctional acrylate, a thermal initiator, a photoinitiator, and a filler wherein the filler comprises clay or calcium carbonate and the filler comprises about 50% or more of the wood putty; and exposing the wood putty to UV light effective to cure the wood putty in less than five minutes. According to the present invention, rapid complete cure of wood putty is achieved, preferably in less than five minutes, more preferably in less than one minute. Because of curing by the present method of frontal polymerization, a depth of cure of more than 1 cm is rapidly achieved. The filler content can be 50% or more, preferably up to 70% or more. The preferred half life temperature of the thermal initiator is less than about 90° C.

### BRIEF DESCRIPTION OF THE FIGURES

FIG. 1 depicts the depth of cured wood putty versus irradiation time for the following formulations: 7.7 wt % ethoxylated trimethylolpropane triacrylate and 7.7 wt % dipentaerythritol pentaacrylate, ˜14.9 wt % trimethylolpropane tris(3-mercaptopropionate), 0.2 wt % photoinitiator of choice and 0.005-0.4 wt % thermal initiator. The diamond (♦) represents the formulation containing photoinitiator Irgacure® 184 and lauroyl peroxide 0.4 wt %, the circle () represents the formulation containing photoinitiator Irgacure® 907 and AIBN 0.3 wt %, and the triangle (▴) representes the formulation containing photoinitiator Irgacure® 907 and lauroyl peroxide 0.4 wt %; Duramite® 68 wt % using a peak irradiance of 43.7 mW/cm².

FIG. 2 depicts viscosity changes of wood putty formulations with filler content. The circle represents Duramite; the square represents Cab-O-Sil 3 wt % with 57 wt % Duramite.

### DETAILED DESCRIPTION OF THE INVENTION

The method of the present invention can rapidly cure composite formulations of the present invention that preferably contain more than 50 wt % inorganic fillers, or, more preferably, formulations that have a filler concentration of more than 70 wt %.

Photoinitiator, acrylate monomer(s), thermal initiator and organic additives such as surfactants are mixed together to form an organic mixture. A quantitative amount of organic mixture is then mixed with filler, such as calcium carbonate, with applicable additives such as clay or Cab-O-Sil. The mixture can be stirred for 30 minutes and sonicated for ten minutes. The organic mixture, filler, and additives can then be premixed using a spatula and mixed vigorously using a mechanical stirrer with a speed of approximately 300 rpm to provide a wood putty formulation. The formulated wood putty can then be applied to an appropriate surface, for example, a wood block. The wood putty is exposed to UV light effective to cure the wood putty formulation in less than five minutes. More preferably, the exposure to UV light cures the wood putty formulation in less than one minute.

In one aspect of the invention, the thermal initiator is azobisisoheptanonitrile, azobisisobutyronitrile, azobisisopentanonitrile, lauroyl peroxide, t-amyl-peroxypivlate, or t-butyl-peroxypivlate. In another aspect the photoinitiator is bis(2,4,6-trimethylbenzoyl)-phenylphosphineoxide, 1-hydroxy-cyclohexyl-phenyl-ketone, 2,2-dimethoxy-1,2-diphenylethan-1-one or 2-methyl-1[4-(methylthio)phenyl]-2-morpholinopropan-1-one.

In still another aspect of the present invention, the multifunctional acrylate is selected from the group consisting of 1,6 hexanediol diacrylate, polyethylene glycol diacrylate, trimethylolpropane triacrylate, ethoxylated trimethylolpropane triacrylate, ditrimethylolpropane tetraacrylate, and dipentaerythritolpenta/hexaacrylate. In one preferred embodiment, the multifunctional acrylate is trimethylolpropane triacrylate.

In a further aspect of the current invention, the peak irradiance is less than 1000 mW/cm², more preferably less than 850 mW/cm², and even more preferably less than 700 mW/cm². Optionally, pigment, trithiol, fumed silica, surfactants, or leveling agents can be added to optimize the wood putty used in the current method.

In another aspect of the invention, the depth of cure of the wood putty is greater than or about 1 cm. Preferably, the depth of cure of the wood putty is between about 1 cm and 10 cm.

### EXAMPLES

### Example 1

### Formulations Analyzed

Various formulations were attempted in optimizing the frontal polymerization of a highly loaded composition. Listed below are several of the formulations used. Experiments detailing the use of the following formulations are described in more detail in the examples. Table 1 provides a cross-reference of the commercial names and the chemical names of several of the photoinitiators and additives used in the formulations. With the exception of a formulation containing acrylate polyesters, the monomers functioned to sustain a front.

Formulation I: Monomer 30 wt %, benzoyl peroxide 0.12 wt %, lauroyl peroxide 0.58 wt %, 1,1-dimethoxyphenylacetophenone 1.8 wt %, Trithiol 9.0 wt %, Cab-O-Sil 2.9 wt %, Duramite 54.9 wt %, yellow colorant 0.4 wt %, red colorant 0.2 wt % and black colorant 0.02 wt %. Light exposure requirements were compared among monomers.

Formulation II: TMPTA˜25%, Displarlon L-1983˜0.25%, Bentonite clay (included in filler content)˜4%, Yellow Colorant 700 ppm, Vazo 52 0.27 wt %, Duramite 71 wt % and trithiol 0.5 wt %. Irgacure® 819 content varies.

Formulation 436-13: Dimethylopropane tetraacrylate (SR 355) 10.2 wt %, trithiol 7.0 wt %, Acrylate polyesters (WEA25) 7.0 wt %, Irgacure® 184 0.34 wt %, Lauroyl peroxide 0.4 wt %, Duramite 75 wt %. Viscosity 200,000˜288,000 cps. System did not support a front.

Formulation 436-42-G1: Organic mixture: 50-g TMPTA, 2-g copolymer of acrylate and acrylic acid (CPAA), 0.5-g Vazo 52, 1-g I-651, 2-g Trithiol. Mix 18-g organic mixture with 40-g Duramite, 1-g MNT-Na Clay, 0.05-g yellow colorant, 0.01-g red colorant. Light exposure requirements: 921 mW/cm², 2.81 J/cm².

Formulation 436-42-B1: Organic Mixture: 50-g TMPTA, 2-g CPAA, 0.5-g Vazo52, 7.5-g trithiol, 1-g I-651. Mix 40-g BRIJ treated Duramite with 17.4-g organic mixture, 1-g MNT-Na Clay, 0.05-g yellow, 0.01-g red 1-g MNT-Na clay, 0.05-g yellow colorant, 0.01-g red colorant. Light exposure requirements: 653 mW/cm², 1.40 J/cm².

Formulation 436-49-B1: Organic mixture: 50-g TMPTA, 0.38-g Vazo52, 0.4-g I-651, 1-g trithiol. Mix 40-g Duramite with 17.4-g organic mixture, 1.5-g Bentonite clay (BNL), 0.05-g yellow colorant, 0.02-g red colorant. Light exposure requirements: 847 mW/cm², 2.45 J/cm².

Formulation 436-51-B1: Organic mixture: 50-g TMPTA, 0.5-g Vazo52, 1-g I-651, No trithiol, 0.2-g benzoin, 5-g SR9035. Mix 40-g Duramite with 17.4-g organic mixture, 0.5-g Bentonite clay (BNCL), 0.05-g yellow colorant, 0.02-g red colorant. Light exposure requirements: 966 mW/cm², 2.81 J/cm².

Formulation 436-51-B2: Organic mixture: 50-g TMPTA, 0.5-g Vazo52, 1-g I-651, 1-g trithiol, 0.2-g benzoin, 5-g SR9035. Mix 40-g Duramite with 17.4-g organic mixture. 0.5-g NMT-Na clay, 0.05-g yellow colorant, 0.02-g red colorant. Light exposure requirements: 926 mW/cm2, 2.62 J/cm².

Formulation 436-51-G2: Organic mixture: 50-g TMPTA, 0.5-g Vazo52, 1-g I-651, 1-g trithiol, 0.3-g BRIJ, 0.1-g TEGO Foamex 805. Mix 44-g Duramite with 22-g organic mixture, 3-g Bentonite clay, 0.05-g yellow colorant, 0.02-g red colorant. Light exposure requirements: 1.05 mw/cm², 3.10 J/cm².

Formulation 436-52-B2: Organic mixture: 50-g TMPTA, 0.5-g Vazo52, 1-g I-651, 1-g trithiol, 0.3-g BRIJ, 0.1-g TEGO Foamex 805. Putty formulated after 18 hours shelf-storage of organic resin by mixing 44-g Duramite with 22-g organic mixture, 3-g Bentonite clay, 0.05-g yellow colorant and 0.02-g red colorant. Light exposure requirements: 838 mw/cm², 2.33 J/cm².

Formulation 410-47-B: Organic mixture: 50-g TMPTA, 2-g CPAA, 1.5-g ITX, 1.5-g AS-3, 1-g I-651, 0.5-g Vazo52 and 0.1-g Formex 805. Putty formulated by mixing 17.4-g organic mixture with 40-g Aresol OT-100 treated Duramite, 0.05-g yellow colorant and 0.01-g red colorant. Light exposure requirements: 1500 mW/cm², 4.84 J/cm².

Formulation 410-46-G: Organic mixture: 50-g TMPTA, 2-g CPAA, 1.5-g ITX, 1.5-g AS-3, 0.5-g Vazo52. Putty formulated by mixing 17.4-g organic mixture with 40-g Aeresol-OT-100 treated Duramite, 1-g MNT-Na Clay, 0.05-g yellow colorant and 0.01-g red colorant. Light exposure requirements: 1130 mW/cm², 3.47 J/cm².

Formulation 410-49-G: Organic mixture: 50-g TMPTA, 0.5-g Vazo52, 1-g Irgacure® 651, 3-g trithiol, 0.59-g Disparlon L-1984. Putty formulated by mixing 20-g organic mixture with 40-g Duramite, 3-g Bentonite clay and 0.05-g yellow colorant. Light exposure requirements: 750 mW/cm², 2.5 J/cm²

Formulation 410-49-G1: Organic mixture:_{—}50-g TMPTA, 0.5-g Vazo52, 1-g Irgacure® 651, 3-g trithiol, 0.59-g Disparlon L-1984. Putty formulated by mixing 20-g organic mixture with 52-g Duramite, 3-g Bentonite clay, 0.05-g yellow colorant and 0.01-g red colorant. Light exposure requirements: 1010 mW/cm², 3.2 J/cm².

Formulation 410-49-G2: Organic mixture: 50-g TMPTA, 1.5-g Vazo52, 1-g I-651, 3-g trithiol, 0.59-g Disparlon L-1984. Putty formulated by mixing 20-g organic mixture with 52-g Duramite, 3-g Bentonite clay and 0.05-g yellow colorant. Light exposure requirements: 888 mW/cm², 2.84 J/cm²

Formulation 410-49-G3: Organic mixture: 50-g TMPTA, 1.5-g Vazo52, 1-g Irgacure® 651, 3-g trithiol, 0.59-g Disparlon L-1983. Putty formulated by mixing 20-g organic mixture with 52-g Duramite, 3-g Bentonite clay and 0.05-g yellow colorant. Light exposure requirements: 942 mW/cm², 2.73 J/cm²

Formulation 410-50-B1: Organic mixture: 50-g TMPTA, 0.5-g Vazo52, 1-g Irgacure® 651, 5-g trithiol, 0.6-g Disparlon L-1983. Putty formulated by mixing 20-g organic mixture with 48-g Duramite, 3-g Bentonite and 0.05-g yellow colorant. Light exposure requirements: 783 mW/cm², 2.60 J/cm².

Formulation 410-50-B2/410-50-B3: Organic mixture: 50-g TMPTA, 1.5-g Vazo52, 1-g Irgacure® 651, 5-g trithiol, 0.6-g Disparlon L-1983. Putty formulated by mixing 20-g organic mixture with 48-g Duramite, 3-g Bentonite and 0.05-g yellow colorant. Light exposure requirements: 484 mW/cm², 1.67 J/cm².

Formulation Vazo-0B: TMPTA 25.3 wt %, Vazo52 0.76 wt %, Trithiol 3.8 wt %, Duramite 70 wt %, red colorant 0.14 wt %, yellow colorant 0.24 wt %, black colorant 0.01 wt %, No other photoinitiator added.

Formulation 436-46-G1: TMPTA 26.4 wt %, Irgacure® 651 0.5 wt %, triphenyl antimony 1.1 wt %, Vazo52 1.6 wt %, Duramite 68.7 wt %, MNT-Na Clay 1.7 wt %, red colorant 0.07 wt %, yellow colorant 0.24 wt %, black colorant 0.007 wt %.

Formulation 436-45-G1: TMPTA 26.4 wt %, Vazo52 1.6 wt %, Irgacure® 651 0.53 wt %, Benzoin 1.0 wt %, Duramite 68.7 wt %, MNT-Na Clay 1.7 wt %, red colorant 0.07 wt %, yellow colorant 0.24 wt %, black colorant 0.007 wt %.

Formulation 436-52-G1: TMPTA 31.5 wt %, CPAA 6.3 wt %, Vazo52 0.32 wt %, Irgacure® 651 0.60 wt %, trithiol 0 wt %, Duramite 59.6 wt %, yellow colorant 0.07 wt %, red colorant 0.03 wt % and MNT-Na clay 1.5 wt %. Viscosity 168,000 cps.

Formulation 410-42-G1: TMPTA 27.1 wt %, CPAA 1.1 wt %, Vazo52 0.27 wt %, trithiol 1.1 wt %, I-651 0.55 wt %, Duramite 68.5 wt %. NMT-Na clay 1.7 wt %, yellow colorant 0.09 wt % and red colorant 0.02 wt %.

Formulation 410-42-B1: TMPTA 24.4 wt %, CPAA 1.0 wt % Vazo52 0.24 wt %, trithiol 3.7 wt %, NMT-Na clay 1.7 wt %, red colorant 0.02 wt %, yellow colorant 0.09 wt % and BRIJ® 76 0.2 wt %.

Formulation 436-53-B1: TMPTA 27.5 wt %, benzophenone 0.83 wt %, MDEA 0.55 wt %, I-651 0.55 wt %, Vazo52 0.28 wt %, Duramite 68.4 wt %, NMT-Na Clay 1.7 wt %, yellow colorant 0.09 wt %, red colorant 0.03 wt %.

Formulation black (410-51-B1): Organic mixture: 60-g TMPTA, 1.8-g Vazo52, 1.8-g Irgacure® 819, 1.2-g trithiol, 0.6-g Disparlon L-1983. Putty formulated by mixing 20-g organic mixture with 44-g Duramite, 3-g Bentonite clay and 0.05-g yellow colorant. Light exposure requirements: 728 mW/cm², 2.35 J/cm².

Formulation Red (410-52-B6): Organic mixture: 60-g TMPTA, 0.6-g Vazo52, 2.3-g Irgacure® 819, 1.2-g trithiol, 0.7-g Disparlon L-1983. Putty formulated by mixing 20-g organic mixture added with 42-g Duramite, 5-g Bentonite clay and 0.05-g yellow colorant. Light exposure requirements: 890 mW/cm², 2.84 J/cm².

Formulation Blue: 60-g TMPTA, 0.6-g Vazo52, 2.3-g Irgacure® 819, 1.5-g trithiol, 1.0-g Disparlon L-1983. Putty formulated by mixing 20-g organic mixture added with 40-g Duramite, 3-g Bentonite clay, 2-g Cab-O-sil and 0.05-g yellow colorant. Viscosity 400,000 cps. Light exposure requirements: 829 mW/cm², 2.66 J/cm²

TABLE 1
Photoinitiators and Additives Cross-Reference with Chemical Name

| Tradename | Chemical name | CAS number |
|---|---|---|
| Irgacure ® 184 | 1-Hydroxy-cyclohexyl-phenyl- | 947-19-3 |
| | ketone | |
| Irgacure ® 907 | 2-Methyl-1[4- | 71868-10-5 |
| | (methylthio)phenyl]-2- | |
| | morpholinopropan-1-one | |
| Irgacure ® 651 | 2,2-Dimethoxy-1,2- | |
| | diphenylethan-1-one | |
| Irgacure ® 819 | Bis (2,4,6-trimethylbenzoyl)- | 162881-26-7 |
| | phenylphosphineoxide | |
| Cab-O-Sil ® | Fumed silica from Cabot Corp. | |
| Duramite ® | Calcium carbonate | |
| trithiol | Trimethylolpropane tris(3- | |
| | mercaptopropionate) | |
| Disparlon L-1983 | Acrylic polymer, leveling agent | |
| | from King Industries | |
| Disparlon L-1984 | Acrylic polymer, leveling agent | |
| | from King Industries | |

### Example 2

### Selection of Thermal Initiators

Thermal initiators are important in sustaining frontal polymerization since the decomposition temperature of the thermal initiator determines the free-radical concentration at the polymerization front. Several peroxides were tested, including Luperox 231, lauroyl peroxide and benzoyl peroxide. Among these peroxides, lauroyl peroxide is the only one with a half-life temperature (80° C.) that achieved successful initiation of frontal polymerization. However, poor solubility of lauroyl peroxide in acrylates causes localized explosion of peroxide pellets leaving macro voids in the final product. Other peroxide candidates with better solubility and appropriate half-life temperatures are Luperox 554 (t-amyl-peroxypivlate) and Luperox 11 (t-butyl-peroxypivalate). An azo compound, azobisisoheptanonitrile, despite of its release of nitrogen during decomposition can also be used. Overall, a one-hour half life temperature below 90° C. is desired.

The use of a benzoyl peroxide/amine complex as thermal initiator was also evaluated. In the presence of amine, a complex between benzoyl peroxide (BPO) and amine is formed. At 30° C., the rate constant for decomposition of benzoyl peroxide is approximately 2*10⁻⁵ l/mol*s, while the thermal decomposition rate constant for benzoyl peroxide-amine is 2*10⁻³ l/mol*s. With several assumptions, including steady-state assumption, an initiation efficiency of 1.0 for BPO and the BPO complex and starting molar concentration of 1 M for each species, a comparison can be made for two species. Using BPO-amine complex, initiating radical concentration decays within 1 hour, suggesting a short operating time (i.e., time from mixing the formulation to applying wood putty on wood blocks). In addition, the change in decomposition rate (i.e., for thermal decomposition) with temperature for the complex may not be necessarily greater than BPO by itself: the greater the change in decomposition rate with temperature, the more suitable it is to be used in frontal polymerization. More than 12 formulations were attempted with various amount of amine added to BPO based formulations. However, after addition of the amine, the formulations either polymerized immediately or no polymerization occurred except for a thin surface of wood putty formulated using BPO-amine complex. Therefore, this particular amine complex redox thermal initiator was not used further.

Selection of thermal initiators was performed by examining solubility as well as the half-life temperature of the selected compound. Table 2 lists several thermal initiators and their half-lives. For the use in a high filler concentration system, there are not many choices that meet the half-life temperature requirement. Thermal initiators with a one-hour half life temperature below 90° C. worked in the highly loaded systems of the present invention.

TABLE 2
One-hour half-life temperature of some thermal initiators.

| | | | Storage | |
|---|---|---|---|---|
| Manufacturer | Name | Chemical Name | Temp. (° C.) | T_{1/2} (° C.) |
| Atofina | Lucidol 78 | Benzoyl peroxide | 30 | 92 |
| Atofina | Luperox | 1,1-di-(t-butylperoxy)-3,3,5- | 30 | 115 |
| | 231 | trimethylcyclohexane | | |
| Atofina | Luperox | t-amyl-peroxypivalate | −10 | 74 |
| | 554 | | | |
| Atofina | Luperox 11 | t-butyl-peroxypivalate | −5 | 76 |
| Atofina | Luperox | Lauroyl peroxide | 27 | 80 |
| Dupont | Vazo 52 | Azobisisoheptanonitrile | 10 | 68 |
| Dupont | Vazo 64 | Azobisisobutyronitrile | 24 | 82 |
| Dupont | Vazo 67 | Azobisisopentanonitrile | 24 | 84 |
| Dupont | Vazo 88 | 1-[(E)-(2- | 35 | 107 |
| | | cyanocyclohexyl)diazenyl] | | |
| | | cyclohexanecarbonitrile | | |

### Example 3

### Frontal Polymerization Versus Conventional Thermal Cure

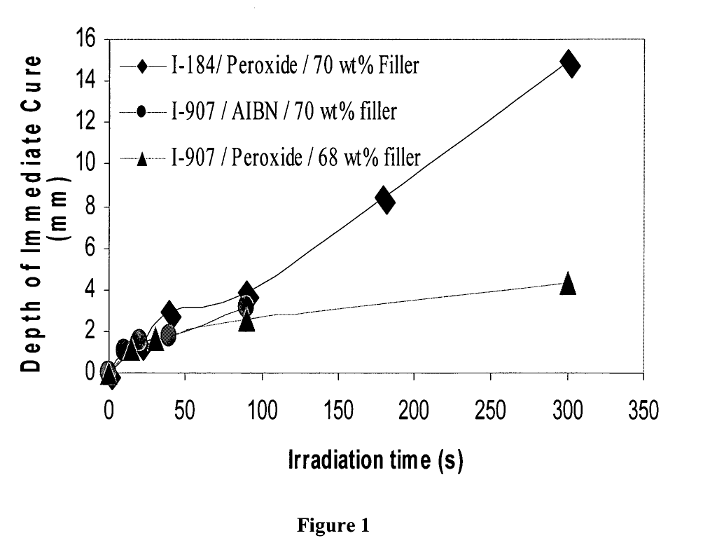

A frontal polymerization involves a traveling front of reacting media in a system and will go to a completion without external heat. As for the conventional thermal cure, external heat is needed to drive polymerization to completion in a reasonable amount of time. Experiments were performed to cure filled wood putty using different UV light sources, including Fusion Power-Cure-3, Fusion EPIQ-6000 and Fusion Light-Hammer-6. Using the Power-Cure-3, samples were placed in the irradiation chamber, and exposed to UV with a peak light irradiance (UVA) from 85-mW/cm² to 158-mW/cm² depending on the sample-to-bulb distance. FIG. 1 shows the depth profile of cured composites with irradiation time. Lauroyl peroxide was used as the thermal initiator in this plot. It appears that Irgacure® 184 may be as efficient as Irgacure® 907 in non-colored systems to generate a burst of heat that initiates the frontal polymerization. Both lauroyl peroxide and AIBN show progressive cure with time. Samples cured from putty material with Irgacure® 907 and Irgacure® 184 cured in approximately equal time to give samples with equivalent properties. However, it was found that samples cured with Irgacure® 184 gave no odor upon sanding while the samples cured with Irgacure® 907 produced an odor (presumably from methyl thiol) when sanded. In other work, Duramite® filled samples (75 wt %) with approximately the same resin compositions as above were evaluated with respect to the depth of cure (measured immediately after exposure to the light source). Both peroxide and AIBN were used as thermal initiators, and Irgacure® 184 and Irgacure® 907 were evaluated as photoinitiators. Preliminary results indicate that only samples cured with Irgacure® 184 gave depths of cure greater than 1 cm upon exposure to light for 300 seconds. Since samples were not evaluated at several times after exposure to the lamp source, it was not possible to tell whether a frontal polymerization or a simple thermal polymerization had occurred.

### Example 4

### Effect of Light Exposure on Frontal Polymerization Using UV Curing Conveyer Belt System

Photocuring of wood putty formulations applied in holes of 1˜1.5 cm in depth and 1 cm in diameter in a wood block was conducted using the Fusion UV belt conveyer systems. The extent of cure was found to depend on a variety of parameters, including the composition of the formulation and light exposure. An initial evaluation of curing with an EPIQ6000 conveyance system was evaluated using a light irradiance of 460 mW/cm² and variable energy density. The depth of cured putty was determined by drilling into the “cured” putty using a mechanical driller right after cure. At a low energy density (i.e., 12 mJ/cm²), the depth of cure increases initially and quickly levels off: starting from the photocuring on the surface with a slow increase in the depth of cure between 2 passes and 10 passes and change to an insignificant propagating rate after 12 passes, suggesting frontal polymerization may not have occurred, i.e., curing appear to be due simply to heating the wood substrate.

With a high energy density per pass, a slow steady increase in the depth of cure was observed between 1 and 6 passes. Beyond 6 passes, a rapid increase in the depth of cure was observed; indicating frontal polymerization may have occurred with the heat accumulated through photopolymerization/thermal polymerization (by the heat from UV lamp) of monomers within a ca. 2-mm top layer. Several of the formulations evaluated, including the intensity and dosage of light exposure are provided below.

Formulation 436-13: Dimethylopropane tetraacrylate (SR 355) 10.2 wt %, trithiol 7.0 wt %, Acrylate polyesters (WEA25) 7.0 wt %, Irgacure® 184 0.34 wt %, Lauroyl peroxide 0.4 wt %, Duramite 75 wt %. Viscosity 200,000˜288,000 cps. System did not support a front.

Formulation 436-42-G1: Organic mixture: 50-g TMPTA, 2-g copolymer of acrylate and acrylic acid (CPAA), 0.5-g Vazo52, 1-g I-651, 2-g Trithiol. Mix 18-g organic mixture with 40-g Duramite, 1-g MNT-Na Clay, 0.05-g yellow colorant, 0.01-g red colorant. Light exposure requirements: 921 mW/cm², 2.81 J/cm².

Formulation 436-42-B1: Organic Mixture: 50-g TMPTA, 2-g CPAA, 0.5-g Vazo52, 7.5-g trithiol, 1-g I-651. Mix 40-g BRIJ treated Duramite with 17.4-g organic mixture, 1-g MNT-Na Clay, 0.05-g yellow, 0.01-g red 1-g MNT-Na clay, 0.05-g yellow colorant, 0.01-g red colorant. Light exposure requirements: 653 mW/cm², 1.40 J/cm².

Formulation 436-49-B1: Organic mixture: 50-g TMPTA, 0.38-g Vazo52, 0.4-g I-651, 1-g trithiol. Mix 40-g Duramite with 17.4-g organic mixture, 1.5-g Bentonite clay (BNL), 0.05-g yellow colorant, 0.02-g red colorant. Light exposure requirements: 847 mW/cm², 2.45 J/cm².

Formulation 436-51-B1: Organic mixture: 50-g TMPTA, 0.5-g Vazo52, 1-g I-651, No trithiol, 0.2-g benzoin, 5-g SR9035. Mix 40-g Duramite with 17.4-g organic mixture, 0.5-g Bentonite clay (BNCL), 0.05-g yellow colorant, 0.02-g red colorant. Light exposure requirements: 966 mW/cm², 2.81 J/cm².

Formulation 436-51-B2: Organic mixture: 50-g TMPTA, 0.5-g Vazo52, 1-g I-651, 1-g trithiol, 0.2-g benzoin, 5-g SR9035. Mix 40-g Duramite with 17.4-g organic mixture. 0.5-g NMT-Na clay, 0.05-g yellow colorant, 0.02-g red colorant. Light exposure requirements: 926 mW/cm², 2.62 J/cm².

Formulation 436-51-G2: Organic mixture: 50-g TMPTA, 0.5-g Vazo52, 1-g I-651, 1-g trithiol, 0.3-g BRIJ, 0.1-g TEGO Foamex 805. Mix 44-g Duramite with 22-g organic mixture, 3-g Bentonite clay, 0.05-g yellow colorant, 0.02-g red colorant. Light exposure requirements: 1.05 mW/cm², 3.10 J/cm².

Formulation 436-52-B2: Organic mixture: 50-g TMPTA, 0.5-g Vazo52, 1-g I-651, 1-g trithiol, 0.3-g BRIJ, 0.1-g TEGO Foamex 805. Putty formulated after 18 hours shelf-storage of organic resin by mixing 44-g Duramite with 22-g organic mixture, 3-g Bentonite clay, 0.05-g yellow colorant and 0.02-g red colorant. Light exposure requirements: 838 mw/cm², 2.33 J/cm².

Formulation 410-47-B: Organic mixture: 50-g TMPTA, 2-g CPAA, 1.5-g ITX, 1.5-g AS-3, 1-g I-651, 0.5-g Vazo52 and 0.1-g Formex 805. Putty formulated by mixing 17.4-g organic mixture with 40-g Aerosol OT-100 treated Duramite, 0.05-g yellow colorant and 0.01-g red colorant. Light exposure requirements: 1500 mW/cm², 4.84 J/cm².

Formulation 410-46-G: Organic mixture: 50-g TMPTA, 2-g CPAA, 1.5-g ITX, 1.5-g AS-3, 0.5-g Vazo52. Putty formulated by mixing 17.4-g organic mixture with 40-g Aresol-OT-100 treated Duramite, 1-g MNT-Na Clay, 0.05-g yellow colorant and 0.01-g red colorant. Light exposure requirements: 1130 mW/cm², 3.47 J/cm².

Formulation 410-49-G: Organic mixture: 50-g TMPTA, 0.5-g Vazo52, 1-g Irgacure® 651, 3-g trithiol, 0.59-g Disparlon L-1984. Putty formulated by mixing 20-g organic mixture with 40-g Duramite, 3-g Bentonite clay and 0.05-g yellow colorant. Light exposure requirements: 750 mW/cm², 2.5 J/cm²

Formulation 410-49-G1: Organic mixture:_{—}50-g TMPTA, 0.5-g Vazo52, 1-g Irgacure® 651, 3-g trithiol, 0.59-g Disparlon L-1984. Putty formulated by mixing 20-g organic mixture with 52-g Duramite, 3-g Bentonite clay, 0.05-g yellow colorant and 0.01-g red colorant. Light exposure requirements: 1010 mW/cm², 3.2 J/cm².

Formulation 410-49-G2: Organic mixture: 50-g TMPTA, 1.5-g Vazo52, 1-g I-651, 3-g trithiol, 0.59-g Disparlon L-1984. Putty formulated by mixing 20-g organic mixture with 52-g Duramite, 3-g Bentonite clay and 0.05-g yellow colorant. Light exposure requirements: 888 mW/cm², 2.84 J/cm²

Formulation 410-49-G3: Organic mixture: 50-g TMPTA, 1.5-g Vazo52, 1-g Irgacure® 651, 3-g trithiol, 0.59-g Disparlon L-1983. Putty formulated by mixing 20-g organic mixture with 52-g Duramite, 3-g Bentonite clay and 0.05-g yellow colorant. Light exposure requirements: 942 mW/cm², 2.73 J/cm²

Formulation 410-50-B1: Organic mixture: 50-g TMPTA, 0.5-g Vazo52, 1-g Irgacure® 651, 5-g trithiol, 0.6-g Disparlon L-1983. Putty formulated by mixing 20-g organic mixture with 48-g Duramite, 3-g Bentonite and 0.05-g yellow colorant. Light exposure requirements: 783 mW/cm², 2.60 J/cm².

Formulation 410-50-B2/410-50-B3: Organic mixture: 50-g TMPTA, 1.5-g Vazo52, 1-g Irgacure® 651, 5-g trithiol, 0.6-g Disparlon L-1983. Putty formulated by mixing 20-g organic mixture with 48-g Duramite, 3-g Bentonite and 0.05-g yellow colorant. Light exposure requirements: 484 mW/cm², 1.67 J/cm².

Formulation black (410-51-B1): Organic mixture: 60-g TMPTA, 1.8-g Vazo52, 1.8-g Irgacure® 819, 1.2-g trithiol, 0.6-g Disparlon L-1983. Putty formulated by mixing 20-g organic mixture with 44-g Duramite, 3-g Bentonite clay and 0.05-g yellow colorant. Light exposure requirements: 728 mW/cm², 2.35 J/cm².

Formulation Red (410-52-B6): Organic mixture: 60-g TMPTA, 0.6-g Vazo52, 2.3-g Irgacure® 819, 1.2-g trithiol, 0.7-g Disparlon L-1983. Putty formulated by mixing 20-g organic mixture added with 42-g Duramite, 5-g Bentonite clay and 0.05-g yellow colorant. Light exposure requirements: 890 mW/cm², 2.84 J/cm².

Formulation Blue: 60-g TMPTA, 0.6-g Vazo52, 2.3-g Irgacure® 819, 1.5-g trithiol, 1.0-g Disparlon L-1983. Putty formulated by mixing 20-g organic mixture added with 40-g Duramite, 3-g Bentonite clay, 2-g Cab-O-sil and 0.05-g yellow colorant. Viscosity 400,000 cps. Light exposure requirements: 829 mW/cm², 2.66 J/cm²

### Example 5

### Selection of Acrylate Monomers

Monomer selection was based upon a variety of properties including: inherent rate of polymerization, inherent extent of cure, double bond content/volume, solubility issues and viscosity. Table 3 provides representative acrylate monomers that were considered within each category of varying functionalities and their proposed likelihood of success. A prescreening process was conducted by examining the availability of monomers and volumetric ene concentration for monomers having the same number of functionality.

TABLE 3
Acrylate Monomers of Varying Functionalities

| Monomer | Description |
|---|---|
| HDDA | Difunctional monomer with high heat content/unit |
| 1,6 hexanediol diacrylate | volume. Attains high conversion rapidly. Low |
| | viscosity. Volatile. High heat content/unit volume. |
| PEG400DA | Difunctional monomer with low heat content/unit |
| Polyethylene glycol diacrylate | volume. Moderate viscosity. Moderate curing |
| (400) | rate. Low heat content/unit volume. |
| TMPTA (trimethylolpropane | Trifunctional monomer with high heat content per |
| triacrylate) | unit volume. Cures rapidly. High heat content/unit |
| | volume. Moderate viscosity. |
| ETMPTA | Trifunctional monomer with high heat content per |
| Ethoxylated (trimethylolpropane | unit volume. Cures rapidly, but to only about 55% |
| triacrylate | conversion. Moderate heat content/unit volume. |
| | Flexibilizing monomer for use in cured matrix |
| | development. Moderate viscosity. |
| Ditrimethylolpropane tetraacrylate | Tetrafunctional monomer with high heat content |
| | per unit volume. Cures very rapidly, but to only |
| | about 40% conversion. High heat content/unit |
| | volume. High viscosity. |
| Dipentaerythritolpenta/hexaacrylate | Hexa/pentafunctional monomer with very high heat |
| (DPPHA) | content per unit volume. Cures very, very rapidly, |
| | but to only about 30-35% conversion. High heat |
| | content/unit volume. High viscosity. |
| Acrylated Cellulose with 10 mol % | Has high viscosity. Possible use in adjusting |
| cellulose rings substituted with | viscosity/rheological properties. This will be used |
| reactive acrylate groups. | in mixture with HDDA since it is a solid polymer |
| | with glass transition of 118° C. |

The general formulation used to compare the performance of the above monomers in UV induced frontal polymerization was: Monomer 30 wt %, benzoyl peroxide 0.12 wt %, lauroyl peroxide 0.58 wt %, 1,1-dimethoxyphenylacetophenone 1.8 wt %, Trithiol 9.0 wt %, Cab-O-Sil 2.9 wt %, Duramite 54.9 wt %, yellow colorant 0.4 wt %, red colorant 0.2 wt % and black colorant 0.02 wt %. Light exposure requirements were compared among monomers.

Limiting light exposure requirements for each monomer to achieve complete cure of wood putty of 1.5 cm in depth were determined. An evaluation of all 7 monomers (with various Duramite fills, 30 wt % trithiol, no colorant) was performed using a Fusion Power Cure Lamp system (125 mW/cm²) with respect to the capability to initiate a curing front. Also, HDDA, TMPTA, ETMPTA and DPPHA (with various Duramite® fills, 30 wt % trithiol, and colorant) with colorant were also evaluated. In cases where the samples were shelf-life stable greater than 30 minutes, Duramite was added until no frontal cure could still be detected. By extensive screening of numerous photoinitiator/thermal peroxide initiator concentrations, it was determined that 3 phr (parts per 100 resin) Irgacure® 651 (2,2-Dimethoxy-1,2-diphenylethan-1-on) with TMPTA were the best compromises for system evaluations.

Without colorant, TMPTA based systems cured with the lowest dose and the greatest Duramite fills of any monomer. A 70 wt % Duramite® system cured completely with a total dose of 6.2 Joules. Without colorant, an ETMPTA sample pre-heated to 40-45° C. cured completely with ˜2 Joules total dose. With colorant, TMPTA with 50 wt % Duramite® cured completely with a total dose of 6.2 Joules. Requiring total energy density of 6.2 J/cm², monomer TMPTA was found to be most effective in sustaining frontal polymerization. The energy density requirement can be reduced significantly by warming wood blocks to 40-45° C. before UV irradiation.

### Example 6

### Photoinitiators

Various photoinitiators have been tested in the formulations. These photoinitiators include Irgacure® 907, Irgacure® 184, Irgacure® 651, Irgacure® 819 and benzoin Among these photoinitiators, Irgacure® 907 and Irgacure® 819 were most effective in initiating frontal polymerization of colorant-containing formulations. However, Irgacure® 907 causes objectionable odor in cured putty samples upon sanding. Generally, for white putty without any colorant, Irgacure® 184 and Irgacure® 651 are also efficient.

In measuring the minimum light exposure requirement needed to initiate frontal polymerization versus concentration of Irgacure® 819, the peak irradiance decreases significantly when the concentration of Irgacure® 819 reaches 0.55 wt % and decreases slowly with Irgacure® 819. The formulation used in this evaluation was TMPTA ˜25%, Displarlon L-1983˜0.25%, Bentonite clay (included in filler content) 4%, Yellow Colorant ˜700 ppm, Vazo52 0.27 wt %, Duramite® 71 wt % and trithiol 0.5 wt % with a varied Irgacure® 819 content. The evaluation was based on minimal light exposure to cure wood putty in holes with 1.5 cm in depth and 1.0 cm in diameter, but depth of cure for frontal polymerization can extend as deep as needed because of the propagating front. The energy density requirement reduces in a steady rate with Irgacure® 819 concentration.

### Example 7

### Properties Enhancement by Addition of Additives

An initial formulation of a UV curable wood putty was developed in order to meet or exceed the properties of currently used water-based putty formulations. The target requirements are included: Modified Janka Hardness, 320; Sandability, Minimal Amount of Residue; Minimal Slumping; Sanding Building Up, Minimal; Shrinkage After Sanding, Minimal; Viscosity (Shear), 300,000-400,000 cps; Color, 1 or Matching wood; Potlife Stability, >8 hours; UV Requirements, 3 J/cm2, 700 mW/cm2. These properties, initially used to evaluate water-based wood putty formulations, were achieved by using 70 wt % Duramite®, 0.5 wt % Vazo52, 3.5 wt % trithiol and an appropriate amount of colorant.

Further evaluation of samples made from this formulation led to new major issues: odor upon sanding and voids in the cured putty. Minimization of odor and voids was achieved by removing two components, thiol and Vazo52. However, these two components (i.e., thiol and Vazo52) are critical in achieving cure within the UV requirements listed above.

In order to maintain reasonable light exposure requirements, the concentration of Vazo52 was initially controlled and various additives were used to reduce voids. These additives include benzoin, fully exchanged sodium form Montmorillonite clay, Bentonite clay, Disparlon® series from King Industries, Inc., and surfactants such as TEGO Foamex 805, Aeresol OT 100, BRIJ® 76 and Drew Plus. Among these additives, Disparlon® 1983 was shown to be the most effective in reducing voids in formulations with more than 70.5 wt % inorganic fillers. Approaches with other additives were also attempted, but none were very successful. Some of the formulations, which were evaluated and failed to eliminate the void problem, are listed below:
1) Monomer mixture of SR9035 (ethoxylated TMPTA) and SR351 (TMPTA) at a ratio of 1:2, no thiol; (436-44-G1)
2) Sample control. No thiol added, with Vazo52; (436-45-B1)
3) Benzoin added, No Thiol. with Vazo52; (436-45-G1, 436-45-G2)
4) Triphenyl phosphine added, with Vazo52; (436-46-B1)
5) Triphenyl antimony added, Vazo52; (436-46-G1)
6) Combination of benzoin and hexanediol dithiol, plus small amount of Vazo52; (436-47-B1)
7) Combination of tetrathiol and Ebecryl 170 (acid containing acrylates), plus small amount of Vazo52 (436-47-G1)
8) Using Bentonite (436-48-B2) and Montmorillonite (436-48-B1) clay;
9) Using minimal amount of Vazo52, and trithiol; (436-49-B1˜4)
10) Using Defoaming agents (Dew-plus); (436-49-G1˜2)
11) Benzoin, Vazo52, trithiol; (436-50-G1˜4) (436-51-B1)
12) Surlyn added, for wetting of Duramite and toughness;
13) Copolymer of acrylate and acrylic acid, for wetting of Duramite and toughness;
14) Added BRIJ® 76, TEGO Foamex 805, check for voids and wetting of Duramite;

### Example 8

### The Best Compromise of Physical Properties and Light Exposure Requirements

The first generation of UV curable wood putty was developed targeting light exposure requirements of an intensity of 700 mW/cm² and a total dosage of 3 J/cm². Besides the use of trithiol for reducing oxygen inhibition, the use of low temperature thermal initiators is also crucial to obtain low light exposure requirements. Vazo52 from Dupont was one of the low temperature thermal initiators. Despite its release of nitrogen gas that can cause voids in the final cured putty, light exposure requirements are lower than 700 mW/cm² and a total dosage of 3 J/cm² Table 2 lists properties of cured putty formulations using Vazo52 and light exposure requirements. Shown in Table 4, even in the absence of other photoinitiators, Formulation Vazo-0B only needs a peak irradiance of 650 mW/cm² to cure completely. When the amount of Vazo52 is not restricted, thiol can be removed from formulations without excessive light exposure requirements. Formulation 436-46-G1 and Formulation 436-45-G1, detailed below, are two examples.

TABLE 4
Performance of First Generation UV Curable Wood Putty.

| Formulation | Vazo-0B | 436-46-G1 | 436-45-G1 |
|---|---|---|---|
| Hardness | Excellent | Excellent | Excellent |
| Sandibility | Excellent | Excellent | Excellent |
| Sanding Build Up | Excellent | Excellent | Excellent |
| Shrinkage After Sanding | Good | None | None |
| Viscosity | 168,000 cps~340,000 cps | | |
| Gunstock Stained/color | Colored | Colored | Colored |
| Light Exposure | 1.6 J/cm², | 1.8 J/cm², | 2.3 J/cm², |
| Requirements | 650 mW/cm² | 730 mW/cm² | 795 mW/cm² |

The first generation wood putty formulations, however, were plagued by two major issues, voids and odor. The origin of voids was found to be associated with the amount of Vazo52 and air trapped in the formulation during processing. Decreasing Vazo52 led to a decrease in the volume of voids at a price of increasing light exposure requirements. Further decreasing of voids was accomplished by adding surfactants and defoaming agents, with Disparlon® 1983 being the most effective as stated above. On the other hand, odor is reduced with decreasing thiol concentration, which results in increased light exposure requirements. While work was performed to find alternatives to thiol and Vazo52; none have been successful. Therefore, final formulations containing minimal amounts of trithiol and Vazo52 involve peak irradiances of about 800˜850 mW/cm². To effectively balance all properties, variations in filler content, Vazo52 concentration and thiol concentration were made; volume of voids and minimal peak irradiances required were determined, as shown in Table 5.

In Table 5, seven formulations were evaluated. Each formulation was applied to holes of 1 cm in diameter and 1.5 cm in depth of a wood block. The wood blocks with uncured wood putty were then passed through a Fusion UV conveyer belt with different combinations of peak irradiance and belt speed. The extent of cure was then immediately examined by drilling into the holes. If the depth of cure exceeded 1 cm, frontal polymerization was assumed. This is because the photoinitated front causes thermal decomposition of the thermal initiators and allows the polymerization front to travel down the depth of the putty applied to the defect to achieve a complete cure. After a series of light exposure, the minimum peak irradiance to initiate frontal polymerization was recorded in the table, which correlates to the filler content, Vazo52 and trithiol concentration. The volume of voids was also examined for these samples. By using ternary plots to evaluate the three variables of filler content, Vazo52 and trithiol concentrations, a formulation for the putty was determined. The best formulation was determined as Formulation red. Another formulation with somewhat more voids and less light exposure requirements is designated as Formulation black. A putty based on the above formulations with improved rheology has also been formulated, designated Formulation blue.

TABLE 5
Effect of filler content, Vazo52 concentration and thiol concentration on
relative volume of voids, required minimal peak irradiance and
energy density.

| | | | Minimum | Minimum | Relative |
|---|---|---|---|---|---|
| Thiol | Vazo52 | Filler | Peak | Energy | Voids |
| Content | Content | Content | Irradiance | Density | Content |
| Percentage | Percentage | Percentage | mW/cm² | mJ/cm² | Percentage |
| 1.5 | 0.24 | 71.3 | 1010 | 3.2 | 5 |
| 1.7 | 0.29 | 68.2 | 885 | 2.9 | 50 |
| 1.4 | 0.84 | 73.3 | 870 | 2.8 | 20 |
| 2.5 | 0.25 | 71.8 | 783 | 2.6 | 10 |
| 2.4 | 0.73 | 71.8 | 484 | 1.7 | 15 |
| 0.56 | 0.28 | 70.1 | 938 | 2.9 | 20 |
| 0.54 | 0.895 | 70.1 | 729 | 2.4 | 50 |

### Example 10

### Viscosity of Optimized Formulations

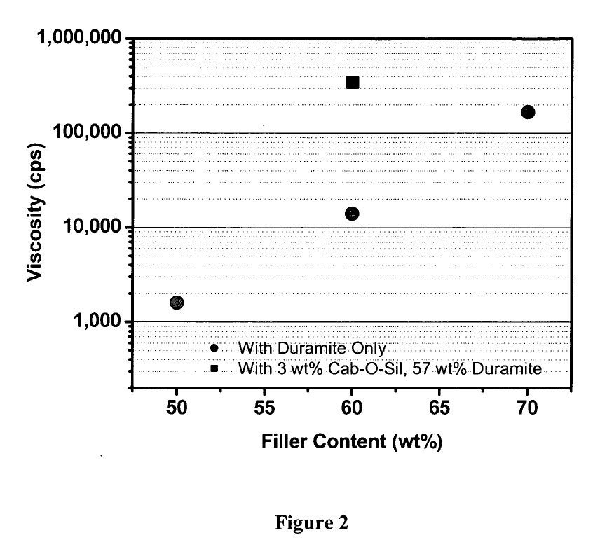

The viscosity of the optimized formulations, formulations red, black, and blue was close to 350,000 cps at an inorganic filler content of 70 wt %˜72 wt %. As the Duramite® content increases, the viscosity increases exponentially. Adjustment of rheology can also be made by using clay or Cab-O-Sil®. As depicted in FIG. 2, when added to a 57 wt % Duramite® sample, incorporation of 3 wt % of Cab-O-Sil® caused a greater increase in viscosity than addition of 10 wt % Duramite®. Also, when Cab-O-Sil® was used, a shear-thinning of the wood putty was observed, a phenomenon that may be helpful in applications.

### REFERENCES

1. Oertel, G.; Polyurethane Handbook 2nd Ed., Hanser: Munich, Germany, 1994
2. Guo, A.; Javni, I.; et al . Appl. Polym. Sci. 2000, 77, 467-473
3. Guo, A.; Demydov, D.; et al, J. Polym. Environ. 2002, 10, 49-52
4. Dwan 'Isa, J. L.; et al, WO 2004/099227, 2004

What is claimed is:

1. A method for repairing a wood defect comprising:
a) applying to the wood defect a wood putty comprising: a multifunctional acrylate, a thermal initiator, a photoinitiator, and a filler wherein the filler comprises clay or calcium carbonate and the filler comprises about 50% or more of the wood putty; and
b) exposing the wood putty to UV light effective to cure the wood putty in less than five minutes.

2. The method of claim 1 wherein the filler comprises about 70% or more of the wood putty.

3. The method of claim 1 wherein the clay is bentonite.

4. The method of claim 1 wherein the multifunctional acrylate is selected from the group consisting of 1,6 hexanediol diacrylate, polyethylene glycol diacrylate, trimethylolpropane triacrylate, ethoxylated trimethylolpropane triacrylate, ditrimethylolpropane tetraacrylate, and dipentaerythritolpenta/hexaacrylate.

5. The method of claim 1 further comprising pigment.

6. The method of claim 1 wherein the wood putty is cured in less than one minute.

7. The method of claim 1 wherein the thermal initiator has a half life temperature of less than about 90° C.

8. The method of claim 7 wherein the thermal initiator is azobisisoheptanonitrile, azobisisobutyronitrile, azobisisopentanonitrile, lauroyl peroxide, t-amyl-peroxypivlate, or t-butyl-peroxypivlate.

9. The method of claim 1 wherein the photoinitiator is bis(2,4,6-trimethylbenzoyl)-phenylphosphineoxide, 1-hydroxy-cyclohexyl-phenyl-ketone, 2,2-dimethoxy-1,2-diphenylethan-1-one or 2-methyl-1[4-(methylthio)phenyl]-2-morpholinopropan-1-one.

10. The method of claim 1 wherein the exposure to UV light is less than 850 mW/cm².

11. The method of claim 1 wherein the wood putty is cured to a depth of at least 1 cm.

12. The method of claim 1 wherein the wood putty is cured to a depth of from about 1 cm to about 10 cm.

13. The method of claim 1 wherein the wood putty further comprises trithiol.

14. The method of claim 1 wherein the wood putty further comprises a leveling agent.

15. The method of claim 1 wherein the wood putty further comprises fumed silica.

16. The method claim 1 wherein the wood putty further comprises a surfactant.
